(19) United States
(12) Patent Application Publication
(10) Pub. No.: US 2014/0127382 A1
(43) Pub. Date: May 8, 2014

(54) GALLATE-TYPE CATECHIN-CONTAINING DRINK

(71) Applicants: Shinsuke Kitanaka, Yamatokooriyama-shi (JP); Yoshimi Haza, Yamatokooriyama-shi (JP); Nobuya Sato, Yamatokooriyama-shi (JP); Akinobu Kishi, Yamatokooriyama-shi (JP); Taiji Matsukawa, Yamatokooriyama-shi (JP); Takeki Matsui, Yamatokooriyama-shi (JP); Yasumasa Yamada, Yamatokooriyama-shi (JP); Ichiro Yamada, Yamatokooriyama-shi (JP)

(72) Inventors: Shinsuke Kitanaka, Yamatokooriyama-shi (JP); Yoshimi Haza, Yamatokooriyama-shi (JP); Nobuya Sato, Yamatokooriyama-shi (JP); Akinobu Kishi, Yamatokooriyama-shi (JP); Taiji Matsukawa, Yamatokooriyama-shi (JP); Takeki Matsui, Yamatokooriyama-shi (JP); Yasumasa Yamada, Yamatokooriyama-shi (JP); Ichiro Yamada, Yamatokooriyama-shi (JP)

(73) Assignee: UHA Mikakuto Co., Ltd., Yamatokooriyama-shi (JP)

(21) Appl. No.: 14/125,500

(22) PCT Filed: Jun. 18, 2012
(86) PCT No.: PCT/JP2012/065531

§ 371 Date: Dec. 11, 2013

(30) Foreign Application Priority Data
Jun. 17, 2011 (JP) 2011-135565
Oct. 28, 2011 (JP) 2011-237784

(51) Int. Cl. A23L 2/52

(52) U.S. Cl. CPC A23L 2/52
USPC 426/590

(57) ABSTRACT

A drink contains (a) gallate-type catechin, (b) collagen having an average molecular weight of 4000 or more, and (c) at least one thickening and stabilizing agent selected from water-soluble soy fiber, gum arabic, pectin, carrageenan, tamarind seed gum, psyllium seed gum, ghatti gum, alginic acid and a salt thereof, polyglutamic acid and a salt thereof, and carboxymethylcellulose, in which the contents (Unit: wt %) [A], [B], and [C] of the components (a), (b), and (c) are in the ranges satisfying the following expressions; i) 0.06≦[A]≦0.6; 3.0≦([B]/[A])≦20.0; and ([C]/[A])≧0.4.

### TECHNICAL FIELD

The present invention relates to a drink containing three components, gallate-type catechin, collagen having an average molecular weight of 4,000 or more, and a thickening and stabilizing agent and a method for manufacturing the same.

### BACKGROUND ART

In recent years, lifestyle-related diseases, such as cancer, cardiac disease, apoplexy, diabetes, high blood pressure, and metabolic syndrome, due to unbalanced dietary habits, stress, smoking, drinking, lack of exercise, and the like have become problematic. It is said that the lifestyle-related diseases occupy 60% or more of the causes of deaths of Japanese. Almost the lifestyle-related diseases are difficult to be completely medically treated. According to the investigation of the Ministry of Health, Labour and Welfare, the Japanese national medical care expenditure in 2010 reached up to 36600 billion yen. Considering the investigation, the age requiring “prevention” of the diseases rather than “treating” of the diseases comes near. From the viewpoint, consumers have become increasingly health-conscious, so that the market of health foods, such as foods for specified health use and foods with nutrient function claims, and dietary supplements have achieved high growth.

In particular, about drinks, the consciousness to health of consumers is high, so that healthy drinks form a stable large market. Moreover, as beauty drinks, the market of collagen drinks has also achieved remarkable growth and is one of the categories which are greatly expected in the future.

As the most familiar healthy functional drink in Japan, green tea is mentioned. With an increase in global health consciousness, green tea is currently a drink which is drunk all over the world. In combination with the Japanese food boom, the export volume of Japanese green tea tends to increase every year. Catechins contained in green tea in a high proportion are expected to show physiological activities, such as antioxidant action, antibacterial action, cancer inhibitory action, cholesterol lowering action, inactivation of influenza virus, and skin protection action against ultraviolet rays. Previously, a large number of products focusing on the physiological activities of catechins have been on the market. Not only tea drinks, such as tea for improving the healthy function also relating to prevention of various cardiovascular disease, tea for preventing absorption of cholesterol, and tea having effects of suppressing accumulation of body fat and accelerating burning of body fat but also soft drinks and the like containing catechins in a high concentration form a new market.

However, it is known that the catechins have peculiar bitter and astringent taste. Among the catechins, gallate-type catechins having a galloyl group in the molecules, such as epicatechin gallate (ECO, epigallocatechin gallate (EGCg), and catechin gallate (Cg), have peculiar astringent taste expressed also as convergent taste and have bitter taste whose strength is 2 to 3 times higher than that of epicatechin (EC) and catechin (C). Thus, for the gallate-type catechins, a method for changing the structure by glycosidation or tannase treatment to reduce the bitter and astringent taste has been attempted (e.g., Patent Documents 1 and 2). However, the gallate-type catechins have high physiological activities to inactivation of human influenza virus, suppression of oxidization of LDL cholesterol, and the like and the present inventors have also found before that ECg and Cg have strong LOX-1 antagonist activity focusing on lectin-like oxidized low density lipoprotein receptor (LOX-1) which is a receptor carrying the action on the vascular endothelial cells by oxidized LDL (Patent Document 3). Therefore, it has been required to reduce the bitter and astringent taste while maintaining the structure of the gallate-type catechins from which high bioactive effects are expected.

Various techniques of masking the bitter and astringent taste of catechins have been already proposed and include, for example, a method for using chinic acid with a specific ratio in combination (Patent Document 4), a method for adding collagen peptide derived from mammals having an average molecular weight of 500 to 4500 (Patent Document 5), and the like. However, although all the methods have achieved a reduction in the bitter and astringent taste of catechins, it has not been able to be said that the masking effect is sufficient.

On the other hand, collagen contained in collagen drinks is present everywhere, such as the skin, blood vessels, internal organs, and bones of animals, and effects of preventing aging of the skin or reducing arthralgia have been expected. Therefore, in recent years, collagen has been widely utilized as beauty and healthy foods and drinks and cosmetics.

However, in the collagen drinks, the unpleasant odor peculiar thereto is a factor of interfering habitual drinking of consumers. Therefore, a large number of techniques of masking the collagen odor have been proposed (e.g., Patent Document 6).

On the other hand, for aggregation and precipitation occurring when protein and polyphenol are simultaneously added, e.g., a combination of collagen and catechins, some techniques of solving the same have been proposed.

For example, a liquid composition containing at least either one of proanthocyanidin or catechins, proteolytic peptide having an average molecular weight of less than 7,000, and peptide or protein having an average molecular weight of 7,000 or more has been proposed (Patent Document 7). However, according to the above-described document, there is no description of palatability, such as taste, and the effect of preventing aggregation and precipitation is insufficient. For example, when only gallate-type catechin and collagen peptide having an average molecular weight of 5,000 or more are mixed, precipitation and aggregation immediately occur.

Moreover, although foods and drinks which contain plant polyphenol, collagen, and basic amino acid, whose pH value is adjusted to 7.5 or more, and in which cloudiness and precipitation are prevented have also been proposed (Patent Document 8) but it cannot be applied to drinks whose pH is in a neutral to acidic region.

Moreover, although there is also a proposal of a collagen peptide containing tea drink having a feature of containing tea extracted liquid on which tannase is made to act and collagen peptide (Patent Document 9). However, since the tannase hydrolyzes the gallate-type catechin, the excellent physiological activities peculiar to the catechin gallate are impaired.

Furthermore, a liquid composition has been proposed in which, by adding pectin as a food additive to a liquid containing plant polyphenol and collagen, the generation of a cloudy substance and/or a precipitate due to the plant polyphenol and the collagen is suppressed (Patent Document 10). The document above also describes Examples using the gallate-type catechin as plant polyphenol. However, when the present inventors also have made attempts to carry out Examples described in the document above, the present inventors feel not only the bitter and astringent taste of the gallate-type catechin but also strong an abnormal taste of pectin which is an additive, so that it has been confirmed that the palatability is poor.

In addition thereto, a liquid composition has also been proposed in which precipitation and aggregation are prevented by adding xyloglucuronomannan to a liquid containing plant polyphenol and water-soluble protein (Patent Document 11). The document does not describe the bitter and astringent taste or the unpleasant taste at all. Moreover, since the xyloglucuronomannan is a substance obtained as a white Jew's-ear extract or the like and is very expensive, the versatility is poor.

Moreover, a polyphenol composition containing cyclodextrin and collagen peptide has also been proposed (Patent Document 12). In the document, Examples using the gallate-type catechin are described. However, according to the invention described in the document above, the precipitation prevention effect has been insufficient, and there is a description of bitter taste, astringent taste, and convergent taste but the effect thereof has been insufficient.

As described above, there have been no drinks in which aggregation and precipitation do not occur even when collagen and catechins, particularly collagen and the gallate-type catechin, are added and furthermore which are free from bitter and astringent taste and have high palatability in spite of the fact that the gallate-type catechin and collagen are contained.

Moreover, in recent years, about tasty beverages, the health consciousness of consumers is high, so that canned coffee, carbonated drinks, beer drinks, and the like which do not contain carbohydrate and whose calorie is reduced steadily increase sales. Among the above, products in which the milk fat content is reduced to reduce lipid and calorie, such as low-fat milk and low-fat-milk coffee, are on the market. However, when the milk fat content is reduced in the drinks containing milk, the mouth-touch feeling is watery and the rich taste in the throat becomes poor. Therefore, various milk fat substitutes, such as cream substitution food component containing non-aggregation denatured protein particles (Patent Document 13) and a cream substitution substance containing particles containing carbohydrate and protein (Patent Document 14), have been proposed. Furthermore, considering the fact that the price of milk raw materials increase in recent years, it is a future significant object to give milk fat feeling while reducing the milk raw materials.

Not only in milk beverages but all drinks, the mouth-touch feeling referred to as “rich taste” and the thick feeling in the throat serve as an important factor of deliciousness. For example, a cloudy soup having good feeling in the throat by adjusting the pH and designing the median diameter of particles to 10 to 100 μm and the like have been proposed (Patent Document 15).

### Citation List

### Patent Literatures

Patent Document 1: Japanese Patent No. 3579496

Patent Document 2: Japanese Patent No. 4739036

Patent Document 3: Japanese Patent Application No. 2011-236448

Patent Document 4: Japanese Patent No. 3378577

Patent Document 5: JP-A No. 2011-15632

Patent Document 6: Japanese Patent No. 4428456

Patent Document 7: Japanese Patent No. 3689413

Patent Document 8: Japanese Patent No. 4653052

Patent Document 9: Japanese Patent No. 4673254

Patent Document 10: Japanese Patent No. 3416102

Patent Document 11: JP-A No. 2010-1275

Patent Document 12: JP-A No. 2008⁻148588

Patent Document 13: Japanese Patent No. 2647219

Patent Document 14: Japanese Patent No. 3626501

Patent Document 15: Japanese Patent No. 4333240

### SUMMARY OF INVENTION

### Technical Problem

It is an object of the invention to provide a drink having high palatability in which the bitter and astringent taste derived from gallate-type catechin and the unpleasant taste derived from collagen are reduced while containing gallate-type catechin and collagen having an average molecular weight of 4,000 or more and a method for manufacturing the same.

It is another object of the invention to provide a drink which is free from aggregation and precipitation and is excellent in stability in addition to the palatability and a method for manufacturing the same.

It is still another object of the invention to provide a drink having mouth-touch feeling with rich taste in addition to the palatability and excellent stability and a method for manufacturing the same.

### Solution to Problem

In order to achieve the objects, the present inventors have repeatedly conducted extensive research, and, as a result, have found that, by mixing a specific thickening and stabilizing agent with gallate-type catechin and collagen having an average molecular weight of 4,000 or more, and then adjusting the content of the three components to a fixed ratio, the bitter and astringent taste and the unpleasant taste of the gallate-type catechin are reduced and also the unpleasant taste of the collagen is masked. The invention has been accomplished based on these findings.

More specifically, the invention relates to the following aspects: (1) A drink contains (a) gallate-type catechin, (b) collagen having an average molecular weight of 4,000 or more, and (c) at least one thickening and stabilizing agent selected from water-soluble soy fiber, gum arabic, pectin, carrageenan, tamarind seed gum, psyllium seed gum, ghatti gum, alginic acid and a salt thereof, polyglutamic acid and a salt thereof, and carboxymethylcellulose, in which the contents (Unit: wt %) [A], [B], and [C] of the components (a), (b), and (c) are in the ranges satisfying the following expressions: i) 0.06≦[A]l≦0.6; ii) 3.0≦([B]/[A])≦20.0; and ([C]/[A])≧0.4,

(2) The drink above, in which the (c) component is water-soluble soy fiber,

(3) The drink above, contains spheroid particles containing the three components (a), (b), and (c) above, in which the particles have an average particle diameter in the range of 1.0 to 50.0 μm,

(4) The drink above, in which the (b) component is gelatin,

(5) A method for manufacturing the drink, includes a process of mixing the following A1 and B2, A2 and B1, or A2 and B2,

A1: (a) component or a solution thereof,

A2: Mixed solution of (a) component and (c) component,

B1: (b) component or a solution thereof, and

B2: Mixed solution of (b) component and (c) component.

### Advantageous Effects of Invention

Due to the fact that the drink of the invention contains gallate-type catechin having high physiological activities and collagen having an average molecular weight of 4,000 or more, the drink is imparted with high palatability which is excellent in the health enhancement effect and the beauty effect and in which, by compounding the specific thickening and stabilizing agent and adjusting the contents of the three components, the bitter and astringent taste derived from the gallate-type catechin and the unpleasant taste derived from collagen are remarkably reduced while containing the gallate-type catechin and the collagen.

Moreover, even when the drink of the invention is stored over a long period of time or heated, aggregation and precipitate do not occur and the stability of a colloidal state is excellent. Therefore, the drink of the invention can be distributed at normal temperature and stored over a long period of time as a packaged drink, for example.

Due to the fact that water-soluble soy fiber is used as the thickening and stabilizing agent in the drink of the invention, the drink of the invention is free from aggregation and precipitation and is excellent in stability particularly when formed into an acid drink in addition to the palatability.

When the (b) component is gelatin, the drink of the invention is a drink which does not form a gel and has low viscosity equivalent to that in a usual case and is more excellent in economical efficiency as compared with the case where collagen peptide is used.

Due to the fact that the drink of the invention contains spheroid particles containing the three components above in which the particles have an average particle diameter in the range of 1.0 to 50.0 μm, the drink of the invention is imparted with excellent mouth-touch feeling and rich taste, such as thick feeling in the throat, in addition to the palatability.

### DESCRIPTION OF EMBODIMENTS

Hereinafter, the invention is described in more detail.

The drink of the invention contains (a) gallate-type catechin, (b) collagen having an average molecular weight of 4,000 or more, and (c) at least one thickening and stabilizing agent selected from water-soluble soy fiber, gum arabic, pectin, carrageenan, tamarind seed gum, psyllium seed gum, ghatti gum, alginic acid and a salt thereof, polyglutamic acid and a salt thereof, and carboxymethylcellulose, in which the contents (Unit: wt %) [A], [B], and [C] of the components (a), (b), and (c) are in the ranges satisfying the following expressions: i) 0.06≦[A]≦0.6; ii) 3.0≦([B]/[A])≦20.0; and ([C]/[A])≧0.4

### (a) Gallate-Type Catechin

The gallate-type catechin is a kind of polyphenol mostly contained in plant tea classified into the camellia species, such as green tea, black tea, or oolong tea and a general term of flavan-3-ols, mainly such as epicatechin (EC), epicatechin gallate (ECg), epigallocatechin (EGC), epigallocatechin gallate (EGCg), catechin (C), and catechin gallate (Cg). In the invention, the “gallate-type catechin” is catechin having a galloyl group in the molecules and specifically refers to ECg, EGCg, Cg, and the like. These gallate-type catechins may be crude articles in addition to refined articles and may be natural substances containing ECg, EGCg, and Cg or processed articles thereof.

The content of the gallate-type catechin ([A]) in the drink of the invention is 0.06 to 0.6 wt %. When the content is less than 0.06 wt %, the catechin amount is equal to or smaller than that of green tea, so that a sufficient effect as a healthy drink cannot be expected. When the content exceeds 0.6 wt %, the catechin amount becomes large, so that the bitter and astringent taste is strongly felt. From the viewpoint that the masking effect of the bitter and astringent taste and the stability of a colloidal state of the drink, the content is preferably 0.06 to 0.5 wt % and more preferably 0.1 to 0.3 wt %.

(b) Collagen having Average Molecular Weight of 4,000 or More

In the invention, the “collagen having an average molecular weight of 4,000 or more” refers to collagen obtained by treating, such as heating, denaturation, and decomposition, a water-insoluble solid collagen to obtain water-soluble collagen and specifically includes from collagen peptide having an average molecular weight of 4,000 or more to gelatin having a molecular weight of about 300,000.

In the invention, the collagen peptide refers to one obtained by hydrolyzing collagen or denatured collagen, such as gelatin, with acid, alkali, an enzyme, or the like. The origin of the collagen serving as the raw material is not particularly limited and those extracted from various animals, such as pig, cow, hen, and fish, can be used.

The average molecular weight of the collagen peptide for use in the invention is 4,000 or more. When the average molecular weight is less than 4,000, the masking effect of the bitter and astringent taste becomes insufficient and the odor and the unpleasant taste of the collagen are strong, so that the palatability of the drink is inferior. The average molecular weight is preferably 5,000 or more, more preferably 7,000 or more, and still more preferably 10,000 or more.

The information on the molecular weight can be obtained by an amount determination method, such as viscosity measurement, HPLC, and a gel filtration method, and known techniques can be used. Herein, the average molecular weight refers to a weight average molecular weight.

In the invention, gelatin can also be used in place of the collagen peptide or with the collagen peptide.

The gelatin for use in the invention may be one obtained by heating and denaturing water-insoluble solid collagen which is protein mostly contained in the bones and the skin of animals and may be soluble protein having an average molecular weight of about several tens of thousands to 300000. In the invention, the gelatin can be used without particular limitation in the organisms from which the gelatin is obtained, the manufacturing method, and the jelly strength.

In the invention, the collagen peptide and gelatin are collectively referred to as “collagen”.

In usual, when the gelatin is used for a drink, the viscosity of the drink increases to form a reversible gel under a fixed temperature, so that the suitability as a drink is lost. However, in the invention, surprisingly, even when the gelatin is used, a drink which does not form a gel and has a low viscosity equivalent to that in a usual case is obtained. Since in the collagen peptide, gelatin is required to be hydrolyzed with an enzyme and the like, the cost is higher than that of the gelatin. Therefore, it is very useful that a collagen drink can be manufactured by the use of gelatin as the raw material.

In the invention, the details of the reason why the gelling of the collagen does not occur are not clear. However, this is considered to be because the collagen is combined with the (a) gallate-type catechin and the (c) thickening and stabilizing agent to form spheroid particles described later, and then form a colloidal state.

In the drink of the invention, the content [B] of the (b) collagen having an average molecular weight of 4,000 or more is preferably 0.3 to 3.0 wt %, more preferably 0.5 to 3.0 wt %, still more preferably 0.8 to 2.0 wt %, and yet still more preferably 1.0 to 2.0 wt % from the viewpoint of showing the function of collagen and the viewpoint of reducing the unpleasant odor of the collagen and giving rich taste.

In the drink of the invention, the content [A] (wt %) of the (a) gallate-type catechin and the content (wt %) [B] of the (b) collagen having an average molecular weight of 4,000 or more is adjusted within the range satisfying the following expression.

3.0≦([B]/[A])≦20.0

When the [B]/[A] is less than 3.0, the effect of masking the bitter and astringent taste derived from the gallate-type catechin is insufficient and the effect of giving rich taste cannot be sufficiently obtained. Moreover, when the [B]/[A] exceeds 20.0, a phenomenon inconvenient for drinks, such as gelling and an increase in viscosity, occurs. The [B]/[A] is more preferably 5.0≦([B]/[A])≦10.0.

(c) Thickening and Stabilizing Agent

The drink of the invention contains at least one kind selected from water-soluble soy fiber, gum arabic, pectin, carrageenan, tamarind seed gum, psyllium seed gum, ghatti gum, alginic acid and a salt thereof, polyglutamic acid and a salt thereof, and carboxymethylcellulose as the (c) thickening and stabilizing agent.

In the invention, the “water-soluble soy fiber” is also referred to as soybean polysaccharide and is water-soluble polysaccharide prepared from insoluble dietary fiber (tofu refuse) produced when manufacturing soybean protein through processes of extraction, refining, sterilization, and drying under weak acidity. The water-soluble soy fiber is constituted by sugar, such as galactose, arabinose, galacturonic acid, rhamnose, xylose, fucose, and glucose. Although the details are not clear, a structure in which galactan and arabinan are combined to a rhamnogalacturonan acid chain is presumed.

Such water-soluble soy fiber is commercially available under the name of “SM-1200” (manufactured by San-Ei Gen F.F.I., Inc.) and “Soyafibe-S” series (manufactured by Fuji Oil Co., Ltd.), for example.

As the thickening and stabilizing agent other than the water-soluble soy fiber, those which are commercially available as food raw materials may be used and the production district and the manufacturing method are not particularly limited.

In the drink of the invention, the content [C] of the thickening and stabilizing agent varies depending on the type and is preferably 0.05 to 3.0 wt %, more preferably 0.1 to 2.0 wt %, still more preferably 0.2 to 2.0 wt %, and yet still more preferably 0.2 to 0.6 wt %. When the content is less than 0.05 wt %, the effect of preventing aggregation and precipitation occurring when the water-soluble collagen and the gallate-type catechin are mixed in an aqueous solution is not sufficiently obtained. When the content exceeds 3.0 wt %, the palatability decreases due to the taste and the viscosity of the thickening and stabilizing agent.

In the drink of the invention, the content [A] (wt %) of the (a) gallate-type catechin and the content (wt %) [C] of the (c) thickening and stabilizing agent are adjusted within the range satisfying the following expression.

([C]/[A])≧0.4

The [C]/[A] is a ratio of the content of the thickening and stabilizing agent to the content of the gallate-type catechin. By setting the ratio to ([C]/[A])–0.4, the effect of preventing the aggregation and precipitation caused when the gallate-type catechin acts with the collagen by the thickening and stabilizing agent is demonstrated. On the other hand, in the case of ([C]/[A])<0.4, since the proportion of the thickening and stabilizing agent becomes low, the aggregation/precipitation prevention effect becomes insufficient. The [C]/[A] is preferably 1.0 or more.

In the drink of the invention, when using the water-soluble soy fiber as the (c) component, it is preferable to contain the same in the following ranges in addition to the content and the ratio of the three components.

[B]/[A]≧5.0 i)

[C]/[B]≧0.08 ii)

By setting the ratio to [B]/[A]≧5.0, the effect of masking the bitter and astringent taste derived from the gallate-type catechin by the collagen is remarkably demonstrated. The [B]/[A] is preferably 6.0 or more.

By setting the ratio to [C]/[B]≧0.08, the effect of preventing the aggregation and precipitation caused when the gallate-type catechin acts with the collagen by the water-soluble soy fiber is remarkably demonstrated. The [C]/[B] is preferably 0.2 or more.

### [Particles]

The drink of the invention forms a cloudy colloidal state due to the fact that the particles containing the three components (a), (b), and (c) are dispersed in water.

It can be confirmed based on the fact that a cloudy colloid is generated by mixing these three components in water that the particles contain the three components, (a), (b), and (c).

It can be confirmed that the shape of the particles is a spheroid shape by visually observing the same under an optical microscope having a magnification of 1,000 times. The spheroid shape is a shape of a body of rotation obtained by rotating an oval around the major axis or the minor axis as the axis of rotation and includes a spherical shape and an oblate sphere. It is important for achieving favorable sensory characteristics, such as mouth-touch feeling, that the shape is an almost spherical shape.

The average particle diameter of the particles is in the range of 1.0 to 50.0 μm. When the average particle diameter is less than 1.0 μm, the thick feeling to the mouth tends to become weak. When the average particle diameter exceeds 50.0 μm, the thick feeling and the stability are poor and precipitation sometimes arises when the drink is allowed to stand still. Furthermore, graininess feeling is sometimes felt to the mouth.

The average particle diameter of the particles is preferably in the range of 1.0 to 20.0 μm and more preferably in the range of 1.0 to 10.0 μm from the viewpoint of giving thick feeling.

The average particle diameter of the particles is measured and calculated using a laser diffraction type particle size meter (e.g., “SALD” series manufactured by Shimadzu Corp.).

The “cloudy colloidal shape” as used in the invention refers to a state where insoluble particles are dispersed to form a cloudy state and has visual feeling similar to that of milk beverages. The cloudiness can be measured by known methods. For example, when the transmittance of light with a wavelength of 600 nm is measured by a spectrophotometer, the cloudiness refers to the fact that the transmittance is 1% or less when the transmittance of distilled water is 100%.

The drink of the invention may contain arbitrary components, such as glucide, fruit juice, vegetable juice, soy milk, dairy products, teas, coffee, alcohols, acidulant, carbon dioxide, flavor, colorant, dietary fiber, vitamins, minerals, amino acid, fats and oils, emulsifier, and high intensity sweetener, as desired. By selecting these arbitrary components as appropriate, the width of the palatability of the drink can be enlarged. The arbitrary components above may be used in the range where the palatability or the physical stability is not adversely affected.

The amount of moisture in the drink of the invention is not particularly limited and is preferably 50 to 99 wt %.

In a method for manufacturing the drink of the invention having the above-described configuration, when the (a) gallate-type catechin, the (b) collagen, and the (c) thickening and stabilizing agent are mixed, it is required to mix and dissolve the (c) component with the (a) component and/or the (b) component beforehand to form a solution state.

More specifically, the drink of the invention can be manufactured by a process of mixing the following A1 and B2, A2 and B1, or A2 and B2.

A1: (a) gallate-type catechin or a solution thereof
A2: Mixed solution of (a) gallate-type catechin and (c) thickening and stabilizing agent
B1: (b) collagen having an average molecular weight of 4,000 or more or a solution thereof
B2: Mixed solution of (b) collagen having an average molecular weight of 4,000 or more and (c) thickening and stabilizing agent

It is preferable that both A1 and B2, both A2 and B1, or both A2 and B2 are diluted with a certain amount of water before mixing. For example, it is preferable that both the substances are diluted with an equivalent amount of water, and then both the substances are mixed to thereby achieve a target concentration. However, the mixing method is not limited to the method above. There are no notable problems insofar as the process includes mixing A1 and B2, A2 and B1, or A2 and B2. On the other hand, when A1 and B1 are mixed first, aggregation cannot be prevented even when the thickening and stabilizing agent or a solution thereof is added later, so that the effects of the invention are not obtained.

The conditions, such as a temperature, when mixing each component, are not particularly limited insofar as the components are not denatured.

The pH of the drink obtained as described above is not particularly limited. An aqueous solution obtained by mixing the three components (a), (b), and (c) generally becomes a neutral drink. The pH may be adjusted by adding a pH adjuster and the like thereto.

For example, although the drink containing the three components (a), (b), and (c) and water generally becomes a neutral drink, the stability is the highest in this case. Even when the drink of the invention is adjusted to basicity, the drink is free from problems of aggregation and precipitation and the like.

When the (c) component is water-soluble soy fiber, the drink of the invention is excellent in stability even when the drink of the invention is acidity by mixing an acid component, such as an acidulant. Therefore, since the drink can be sterilized by heating in accordance with the sterilization standard of a soft drink based on Food Sanitation Law of Japan, the drink can be distributed at normal temperature and can be stored over a long period of time as a packaged drink. With respect to an acid soft drink, the sterilization standards equal to or higher than 65° C. for 10 minutes when the pH is less than 4.0 and equal to or higher than 85° C. for 30 minutes when the pH is 4.0 to 4.6 are established.

### EXAMPLES

Hereinafter, the invention is more specifically described with reference to Examples but the invention is not limited at all thereto.

### Example I-1

0.2 g of EGCg (Product name: Sunphenon EGCg manufactured by Taiyo Kagaku Co., Ltd.) and 0.5 g of water-soluble soy fiber (Product name: Soyafibe S-ZR100 manufactured by Fuji Oil Co., Ltd.) were melted in 60° C. water to produce an aqueous solution with a total amount of 50 g. An aqueous solution prepared by melting 1.5 g of collagen peptide (Product name: SCP-5100 manufactured by Nitta Gelatin, Inc., Average molecular weight of 5,000) to give a total amount of 50 g was added thereto, thereby obtaining 100 g of a colloidal white liquid without aggregation and precipitation. The obtained drink was subjected to a sensory test by five panelists. The results obtained by a sensory evaluation method described below are shown in Table I-1. Moreover, the evaluation results of the presence or absence of precipitation after the drink was allowed to stand at room temperature for 1 hour or for one day and the presence or absence of aggregation and precipitation when citric acid was added to adjust the pH to 3.9 are also shown together.

TABLE I-1

| | | | | | | Bitter and | Unpleasant | |
|---|---|---|---|---|---|---|---|---|
| | | Dietary fiber | Precipitation | Precipitation | Precipitation | astringent | taste | Abnormal |
| | Dietary fiber type | content (%) | after 1 hour | after 1 day | under acidity | taste strength | strength | taste |
| Example I-1 | Water-soluble soybean | 0.5 | Not-occurred | Not-occurred | Not-occurred | 4.2 | 1.4 | Not-occurred |
| | dietary fiber | | | | | | | |
| Example I-2 | Water-soluble soybean | 2.0 | Not-occurred | Not-occurred | Not-occurred | 3.6 | 1.4 | Not-occurred |
| | dietary fiber | | | | | | | |
| Comparative | Water-soluble soybean | 0.03 | Occurred | — | — | — | — | — |
| Example I-1 | dietary fiber | | | | | | | |
| Comparative | Water-soluble soybean | 4.0 | Not-occurred | Not-occurred | Not-occurred | 3.2 | 1.4 | Occurred |
| Example I-2 | dietary fiber | | | | | | | |
| Comparative | Inulin *1 | 0.5 | Occurred | — | — | — | — | — |
| Example I-3 | | | | | | | | |
| Comparative | Indigestible dextrin *2 | 0.5 | Occurred | — | — | — | — | — |
| Example I-4 | | | | | | | | |
| Comparative | β-Cyclodcxtrin *3 | 0.5 | Occurred | — | — | — | — | — |
| Example I-5 | | | | | | | | |
| Comparative | Polydextrose *4 | 0.5 | Occurred | — | — | — | — | — |
| Example I-6 | | | | | | | | |
| Comparative | Crystalline cellulose *5 | 0.5 | Occurred | — | — | — | — | — |
| Example 1-7 | | | | | | | | |
| Comparative | — | — | Not-occurred | Not-occurred | Not-occurred | — | 2.0 | Not-occurred |
| Example I-8 | | | | | | | | |
| Comparative | — | — | Occurred | — | — | — | — | — |
| Example I-9 | | | | | | | | |

*1 Product name: Orafti HP, manufactured by Beneo
*2 Product name: Fibersol 2, manufactured by Matsutani Chemical Industry Co., Ltd.
*3 Manufactured by Pearl Ace Corporation
*4 Product name: Litesse Ultra, manufactured by Danisco
*5 Product name: Ceolus DX-2, manufactured by Asahi Kasei Chemicals Corporation

### <Sensory Evaluation Method>

### (1) Evaluation of Bitter and Astringent Taste

Five panelists evaluated the bitter and astringent taste strength of each test liquid on the basis of the EGCg standard solution shown in the following table 2 on a scale of one to ten, and the average value was the grade. The test liquids of the grade of 5.0 or less were acceptable products.

TABLE I-2
<EGCg standard solution>

| Bitter and astringent | EGCg concentration |
|---|---|
| taste strength | (g/100 mL aq.) |
| 1 | 0.0150 |
| 2 | 0.0200 |
| 3 | 0.0267 |
| 4 | 0.0356 |
| 5 | 0.0475 |
| 6 | 0.0633 |
| 7 | 0.0844 |
| 8 | 0.1125 |
| 9 | 0.1500 |
| 10 | 0.2000 |

(2) Evaluation of Unpleasant Taste of Collagen

Five panelists evaluated the unpleasant taste strength of each test liquid according to the criteria shown in the following table I-3 on a scale of one to three, and the average value was the grade. The test liquids of the grade of 1.8 or less were acceptable products.

TABLE I-3

| Unpleasant | |
|---|---|
| taste strength | Criteria |
| 1 | Unpleasant taste of collagen is not felt |
| 2 | Unpleasant taste of collagen is slightly felt |
| 3 | Unpleasant taste of collagen is strongly felt |

(3) Evaluation of Abnormal Taste

When there are three or more panelists among the five panelists felt an abnormal taste different from the bitter and astringent taste or the taste of collagen, it was judged that an abnormal taste arose.

### Example I-2, Comparative Examples I-1 to I-7)

A drink was produced in the same manner as in Example 1, except changing the water-soluble soy fiber of Example I-1 to another dietary fiber and a thickening and stabilizing agent. The sensory test was performed only for one in which aggregation and precipitation did not occur. Moreover, one in which the addition amount of the water-soluble soy fiber was changed was produced. The sensory test results of the drinks are shown in Table I-1.

### Comparative Example I-8

Using the same collagen peptide as that of Example I-1, a drink in which the collagen peptide was compounded in water in such a manner as to give the same concentration as that of Example I-1 was produced. The sensory test results are shown in Table I-1.

### Comparative Example I-9

A drink was produced in the same manner as in Example I-1, except not adding the water-soluble soy fiber of Example I-1. Aggregation of collagen occurred immediately after mixing. The sensory test results are shown in Table I-1.

From the results of Table I-1, in all the drinks obtained in Examples I-1 and I-2, all the evaluations were more excellent than the drinks of Comparative Examples I-1 to 1-9 in that precipitation did not occur even after 1 hour to 1 day passed and precipitation did not occur under acidity, and, in terms of the taste, the bitter and astringent taste and the unpleasant taste were weak and the drinks were free from abnormal taste.

### Examples I-3 to I-5, Comparative Examples I-10 to I-12

Drinks were produced in the same manner as in Example I-1, except changing the addition amount and the average molecular weight of the collagen peptide of Example I-1. The sensory test results of these drinks are shown in Table I-4.

### Example I-6

A drink was produced in the same manner as in Example I-1, except changing the collagen peptide of Example I-1 to gelatin (Product name: APH-250, Average molecular weight of 120,000, manufactured by Nitta Gelatin, Inc. The same applies to the following description.). Although the obtained drink contained gelatin in place of collagen peptide, the drink did not cause gelling and formed a stable colloidal solution (Average particle diameter 9.3 μm) similarly as in Example I-1. The sensory test results are shown in Table I-4.

### Example I-7

A drink was produced in the same manner as in Example 1, except using a mixture of gelatin and collagen peptide (1:1) in place of the collagen peptide of Example I-1. Although the obtained drink contained gelatin, the drink did not cause gelling and formed a stable colloidal solution. The sensory test results are shown in Table I-4.

TABLE I-4

| | | Collagen | | | | Bitter and | Unpleasant | |
|---|---|---|---|---|---|---|---|---|
| | | content | Precipitation | Precipitation | Precipitation | astringent | taste | Abnormal |
| | Collagen type | (%) | after 1 hour | after 1 day | under acidity | taste strength | strength | taste |
| Example I-1 | SCP-5100 (Average molecular | 1.5 | Not-occurred | Not-occurred | Not-occurred | 4.2 | 1.4 | Not-occurred |
| | weight of 5,000) | | | | | | | |
| Example I-3 | SCP-5100 (Average molecular | 3.0 | Not-occurred | Not-occurred | Not-occurred | 3.6 | 2.0 | Not-occurred |
| | weight of 5,000) | | | | | | | |
| Comparative | SCP-5100 (Average molecular | 0.9 | Not-occurred | Not-occurred | Not-occurred | 6.8 | 1.2 | Not-occurred |
| Example I-10 | weight of 5,000) | | | | | | | |
| Comparative | SCP-2000 (Average molecular | 1.5 | Not-occurred | Not-occurred | Not-occurred | 9.0 | 2.6 | Not-occurred |
| Example I-11 | weight of 2,000) | | | | | | | |
| Comparative | SCP-3100 (Average molecular | 1.5 | Not-occurred | Not-occurred | Not-occurred | 7.2 | 2.2 | Not-occurred |
| Example I-12 | weight of 3,000) | | | | | | | |
| Example I-4 | Nippi peptide PA-100 (Average | 1.5 | Not-occurred | Not-occurred | Not-occurred | 3.2 | 1.2 | Not-occurred |
| | molecular weight of 10,000)* | | | | | | | |
| Example I-5 | HBC-P20 (Average molecular | 1.5 | Not-occurred | Not-occurred | Not-occurred | 2.8 | 1.2 | Not-occurred |
| | weight of 20,000) | | | | | | | |
| Example I-6 | APH-250 (250 Bloom gelatin) | 1.5 | Not-occurred | Not-occurred | Not-occurred | 2.0 | 1.8 | Not-occurred |
| Example I-7 | APH-250:SCP-5100 = 1:1 | 1.5 | Not-occurred | Not-occurred | Not-occurred | 2.0 | 1.8 | Not-occurred |

*Manufactured by Nippi, Inc. (Other gelatins are all manufactured by Nitta Gelatin, Inc.)

From the results of Table I-4, in the drinks obtained in Examples I-3 to I-7, the evaluation in a respect that both the bitter and astringent taste and the unpleasant taste were weak was more excellent than the drinks of Comparative Examples I-10 to I-12.

### Example I-8

50 g of a solution containing 0.2 g of EGCg (Product name: Sunphenon EGCg manufactured by Taiyo Kagaku Co., Ltd.) was added to 50 g of a mixed solution containing 1.5 g of collagen peptide (Product name: SCP-5100 manufactured by Nitta Gelatin, Inc., Average molecular weight of 5,000) and 0.5 g of water-soluble soy fiber (Product name: Soyafibe S-ZR100 manufactured by Fuji Oil Co., Ltd.), thereby obtaining 100 g of a colloidal white liquid having the same formula as that of Example 1. The liquid was a drink free from aggregation and precipitation and also bitter and astringent taste and unpleasant taste similarly as in Example I-1.

### Example I-9

A drink was produced by performing the same operation as that of Example I-1, except changing EGCg of Example I1 to ECg. As a result, a drink free from aggregation and precipitation and also bitter and astringent taste and unpleasant taste similarly as in Example I-1 was obtained. As the ECg, one which was extracted from tea and then refined by a usual method was used.

### Examples I-10 to I-12

Drinks were prepared by the same operation as that of Example I-1 using EGCg (Product name: Sunphenon EGCg manufactured by Taiyo Kagaku Co., Ltd.), water-soluble soy fiber (Product name: Soyafibe S-ZR100 manufactured by Fuji Oil Co., Ltd.), and collagen peptide (Product name: HBC-P20, manufactured by Nitta Gelatin, Inc., Average molecular weight of 20,000) in such a manner that each drink has the content shown in Table 1-5. All the drinks were free from aggregation and precipitation and also bitter and astringent taste and unpleasant taste similarly as in Example I-1

TABLE I-5

| | [A] | [B] | [C] | [B]/[A] | [C]/[A] | [C]/[B] |
|---|---|---|---|---|---|---|
| Example I-10 | 0.06 | 0.30 | 0.30 | 5.00 | 5.00 | 1.00 |
| Example I-11 | 0.50 | 3.00 | 3.00 | 6.00 | 6.00 | 1.00 |
| Example I-12 | 0.125 | 0.625 | 0.05 | 5.00 | 0.40 | 0.080 |

[A] Content of catechin gallate [wt %]
[B] Content of collagen having an average molecular weight of 4,000 or more [wt %]
[C] Content of water-soluble soybean dietary fiber [wt %]

### Example I-13

Water was added to 5 g of concentrated white peach fruit juice, 10 g of fructose-glucose liquid sugar, 0.1 g of citric acid, 0.05 g of vitamin C, 0.1 g of peach flavor, 0.3 g of water-soluble soy fiber (Product name: SM-1200 manufactured by San-Ei Gen F.F.I., Inc.), and 0.15 g of EGCg for melting to give a total amount of 80 g. Then, 20 g of 5 wt % aqueous solution of collagen peptide (Product name: HBC-P20 manufactured by Nitta Gelatin, Inc., Average molecular weight of 20,000) was added and mixed, heated at 65° C. for 10 minutes, and then charged into a container, thereby producing 100 g of a peach fruit juice drink having a pH of 3.7. The obtained drink was a drink with high palatability in which neither aggregation nor precipitation occurred and neither bitter and astringent taste nor the unpleasant taste were exhibited, and from which the collagen, the gallate-type catechin, and the water-soluble dietary fiber can be taken without difficulty.

The drink was subjected to a storage test under an environment of 50° C. for one day and 37° C. for 30 days. Then, the drink did not cause aggregation and precipitation and formed a stable colloid.

### Examples II-1 to II-9, Comparative Examples II-1 to II-4)

1 g of collagen peptide (Product name: HBC-P20 manufactured by Nitta Gelatin, Inc., Average molecular weight of 20,000) and a thickening and stabilizing agent shown in Table II-1 was melted in 60° C. water, thereby obtaining an aqueous solution with a total amount of 90 g. An aqueous solution prepared by melting 0.2 g of a gallate-type catechin containing tablet (Product name: Sunphenon 90S, Gallate-type catechin content of 66 wt %, manufactured by Taiyo Kagaku Co., Ltd.) in 60° C. water to give a total amount of 10 g was added thereto, and then 100 g of a drink which became cloudy and had a colloidal state was obtained. When the drinks obtained in Examples II-1 to II-9 were measured for the transmittance of light with a wavelength of 600 nm by a spectrophotometer, the transmittance was all 1% or less when the transmittance of distilled water was 100%.

The obtained drinks were subjected to particle size distribution measurement and a sensory test by five panelists. The results obtained by a test method described below are shown in table II-1.

Moreover, when each sample was observed under an optical microscope (“BX41” manufactured by Olympus Corporation) having a magnification of 1,000 times, it was confirmed that the particles constituting the cloudy colloid contained in each sample had a spheroid shape.

### <Particle Size Distribution Measuring Method>

The average particle diameter was measured by a known method using a laser diffraction type particle size distribution meter (“SALD-2000J” manufactured by Shimadzu Corp.). As a specific operation, each sample was shaken, diluted in 5 to 10 times as much water, and then placed in a sampler stirring vessel. Then, a pump rate adjustment knob was set to the position of 6, and then the particle size distribution was measured under stirring. As the distribution basis, the volume basis (the ratio of specific particles occupying the total volume of all the particles) was used. The average particle diameter was calculated by software for the device (Wing-SALD-2000J manufactured by Shimadzu Corp.).

### <Sensory Test Method>

### (1) Evaluation of Rich Taste

Five panelists evaluated rich taste according to the criteria shown below on a scale of one to three, a value obtained by rounding the average value, and indicating the value in an integer was the grade.

### Grade: Criteria

1: Mouth-touch feeling is not felt and watery is felt. Or graininess feeling is felt.
2: Mouth-touch feeling and feeling in the throat are slightly felt.
3: Mouth-touch feeling and feeling in the throat are felt.
(2) Evaluation of bitter and astringent taste

Five panelists evaluated bitter and astringent taste strength according to the criteria shown below on a scale of one to three, a value obtained by rounding the average value, and indicating the value in an integer was the grade.

### Strength: Criteria

1: Bitter and astringent taste is hardly felt.
2: Bitter and astringent taste is felt.
3: Bitter and astringent taste is strongly felt.

TABLE II-1

| | Thickening and | Thickening and | | | Bitter and |
|---|---|---|---|---|---|
| | stabilizing | stabilizing agent | Average particle | Rich taste | astringent |
| | agent type | content [wt %] | diameter [μm] | evaluation | taste evaluation |
| Example II-1 | Gum arabic *1 | 0.4 | 8.7 | 3 | 1 |
| Example II-2 | Pectin *2 | 0.2 | 1.4 | 3 | 1 |
| Example II-3 | Carrageenan *3 | 0.2 | 3.9 | 3 | 1 |
| Example II-4 | Tamarind seed gum *4 | 0.2 | 3.0 | 3 | 1 |
| Example II-5 | Psyllium seed gum *5 | 0.4 | 16.1 | 3 | 1 |
| Example II-6 | Ghatti gum *6 | 0.4 | 1.1 | 3 | 1 |
| Example II-7 | Alginic acid Na *7 | 0.4 | 1.0 | 3 | 1 |
| Example II-8 | Polyglutamic acid Na *8 | 0.4 | 10.2 | 3 | 1 |
| Example II-9 | Carboxymethylcellulose *9 | 0.4 | 1.2 | 3 | 1 |
| Comparative | Guar gum *10 | 0.2 | 94.9 | 1 | 1 |
| Example II-1 | | | | | |
| Comparative | Locust bean gum *11 | 0.2 | 190.9 | 1 | 1 |
| Example II-2 | | | | | |
| Comparative | Tara gum *12 | 0.2 | 53.2 | 2 | 1 |
| Example II-3 | | | | | |
| Comparative | Casein Na *13 | 0.4 | 0.7 | 1 | 1 |
| Example II-4 | | | | | |

*1) Product name: Instant gum AB manufactured by Colloides Naturels International
*2) Product name: UNIPECTINE AYD3110SB manufactured by Cargill
*3) Product name: GENUTINE type X-9303 manufactured by Sansho Co., Ltd.
*4) Product name: TG120 manufactured by MRC polysaccharide Co., Ltd.
*5) Product name: PG020 manufactured by MRC polysaccharide Co., Ltd.
*6) Product name: Ghatti gum SD manufactured by San-Ei Gen F.F.I., Inc.
*7) Product name: NEWGELIN SP manufactured by Chuo Foods Material Co., Ltd.
*8) Product name: BLS-PGA (Na form) manufactured by BioLeaders Corporation
*9) Product name: Serogen F-SL manufactured by Dai-ichi Kogyo Seiyaku Co., Ltd.
*10) Product name: VIDOCREM A manufactured by Unipektin
*11) Product name: GENUGUM type RL-200-J manufactured by Sansho Co., Ltd.
*12) Product name: VIDOGUM SP-175 manufactured by Unipektin
*13) Manufactured by San-Ei Gen F.F.I., Inc.

From the results of Table II-1, the drinks obtained in Examples II-1 to II-9 were excellent in rich taste, such as good mouth-touch feeling and good feeling in the throat, and bitter and astringent taste was hardly felt.

On the other hand, in the drinks obtained in Comparative Examples II-1 to II-4, rich taste, such as good mouth-touch feeling and good feeling in the throat, was difficult to feel as compared with the drinks of Examples II-1 to II-9.

### Examples II-10 to II-12, Comparative Example II-5)

Collagen with an amount (unit: g) shown in table II-2 was melted in 60° C. water to thereby produce an aqueous solution with a total amount of 90 g. An aqueous solution prepared by melting EGCg (Product name: Sunphenon-EGCg, Gallate-type catechin content of 95 wt % or more, manufactured by Taiyo Kagaku Co., Ltd.) with an amount (unit: g) shown in Table II-2 and 0.8 g of gum arabic (Product name: Instant gum AB, manufactured by Colloides Naturels International) in 60° C. water to give a total amount of 20 g was added thereto, thereby obtaining 100 g of a drink. About the obtained drink, the results obtained by the same test method as that of Example II-1 are shown in table II-2.

TABLE II-2

| | | | Compar- | |
|---|---|---|---|---|
| | | | ative | |
| | Example | Example | Example | Example |
| | II-10 | II-11 | II-5 | II-12 |
| Collagen peptide having | 2 | 1.6 | 1 | |
| an average molecular | | | | |
| weight of 20,000 | | | | |
| Gelatin *1 | | | | 1 |
| EGCg | 0.1 | 0.2 | 0.5 | 0.2 |
| [B]/[A] | 20 | 8 | 2 | 5 |
| Average particle | 2.3 | 1.6 | 0.4 | 4.7 |
| diameter [μm] | | | | |
| Rich taste evaluation | 3 | 3 | 1 | 3 |
| Bitter and astringent | 1 | 1 | 2 | 1 |
| taste evaluation | | | | |

1* Product name: APH-250 manufactured by Nitta Gelatin, Inc.

From the results of Table II-2, the drinks obtained in Examples II-10 to II-12 were all excellent in rich taste, such as good mouth-touch feeling and good feeling in the throat, and bitter and astringent taste was hardly felt as compared with the drinks obtained in Comparative Example II-5.

### Example II-13, Comparative Examples II-6 and II-7)

Drinks were produced by performing the same operation as that of Example II-11, except changing EGCg of Example II-11 to ECg (Example II-13), EGC (Comparative Example II-6), and (+)—catechin (Comparative Example II-7) (all available as a reagent from Wako Pure Chemical Industries, Ltd.). The same effects as those in the case of EGCg were obtained in the case of ECg. However, in EGC and (+)—catechin, drinks in which clouding hardly occurred and mouth-touch feeling and rich taste were poor were obtained.

### Example II-14

55 g of 20 wt % aqueous solution of gelatin (Product name: APH-250 manufactured by Nitta Gelatin, Inc.) was added to and mixed with an aqueous solution with a total amount of 645 g obtained by melting 65 g of sugar, 2 g of carboxymethylcellulose (Product name: Serogen F-SL manufactured by Dai-ichi Kogyo Seiyaku Co., Ltd.), 10 g of tea extract powder, and 0.2 g of milk flavor in 60° C. water. Then, an aqueous solution prepared by melting 2 g of gallate-type catechin containing tablet (Product name: Sunphenon 90S, Gallate-type catechin content of 66 wt %, manufactured by Taiyo Kagaku Co., Ltd.) in 60° C. water in such a manner as to give a total amount of 300 g was added thereto, thereby producing 1000 g of a tea drink with milk flavor. The obtained drink was a tea drink with milk flavor free from bitter and astringent taste and unpleasant taste of collagen and having sensory characteristics like milk fat in spite of containing no fat.

1. A drink, comprising:
(a) gallate-type catechin;
(b) collagen having an average molecular weight of 4,000 or more; and
(c) at least one thickening and stabilizing agent selected from water-soluble soy fiber, gum arabic, pectin, carrageenan, tamarind seed gum, psyllium seed gum, ghatti gum, alginic acid and a salt thereof, polyglutamic acid and a salt thereof, and carboxymethylcellulose, wherein contents (Unit: wt %) of [A], [B], and [C] of the components (a), (b), and (c) are in ranges satisfying the following expressions:
0.06≦[A]≦0.6; i)
3.0 ≦([B]/[A])≦20.0; and ii)
([C]/[A])–0.4.

2. The drink according to claim 1, wherein the (c) component is water-soluble soy fiber.

3. The drink according to claim 1, comprising spheroidal particles containing the three components (a), (b), and (c), wherein the particles have an average particle diameter in a range of 1.0 to 50.0 μm.

4. The drink according to claim 1, wherein the (b) component is gelatin.

5. A method for manufacturing the drink according to claim 1, comprising:
a step of mixing the following A1 and B2, A2 and B1, or A2 and B2,
A1: (a) component or a solution thereof,
A2: Mixed solution of (a) component and (c) component,
B 1: (b) component or a solution thereof, and B2: Mixed solution of (b) component and (c) component.
